(19) United States
(12) Patent Application Publication
(10) Pub. No.: US 2026/0241421 A1
(43) Pub. Date: Aug. 20, 2026

(54) Washer System

(71) Applicant: Sani-Matic, Inc., Sun Prairie, WI (US)

(72) Inventors: Michael Jeffrey Borkowski, McFarland, WI (US); Bryan Keith Downer, Springfield, MO (US); Scott Steven Norton, Evansville, WI (US)

(21) Appl. No.: 19/190,319

(22) Filed: Apr. 25, 2025

Related U.S. Application Data
(60) Provisional application No. 63/639,314, filed on Apr. 26, 2024.

(51) Int. Cl. B08B 3/02; B08B 13/00; B08B 15/02; B62B 3/00

(52) U.S. Cl. CPC B08B 3/024; B08B 13/00; B08B 15/02; B62B 3/005; B08B 2203/02

(57) ABSTRACT

A washer system for cleaning items includes a wash chamber with a spray bar and a door, and a movable cleaning cart configured to accommodate a plurality of items to be cleaned. The cleaning cart includes a bottom wheel portion configured to be moved on a surface and a top rack portion, wherein the bottom wheel portion and the top rack portion are spaced apart. The cleaning cart is configured to be inserted into the wash chamber through the door and is configured to remain in the wash chamber during a wash cycle. The spray bar is configured to rotate without any power input.

### FIELD OF THE INVENTION

The present technology relates to a washing system for food industry. In particular, the present technology relates to an automated parts washer with a removable sanitation assembly for holding the parts to be cleaned.

### BACKGROUND OF THE INVENTION

There are known washing systems for food industry that wash food remnants and other substances adhered to parts or items to be cleaned by using a detergent and wash water. The known washing systems are typically provided with racks for placing parts/items thereon inside a washing cabinet, the racks being vertically moved in a backward and forward direction to be inserted into and drawn out from the washing cabinet.

Conventional washing systems have a number of disadvantages. Primarily, the parts/items to be cleaned have to be loaded into racks inside a washer before the cleaning cycle begins and have to be unloaded and taken out of the washer one by one after the cleaning is completed. This takes time and effort to accomplish, which is disadvantageous, especially in a context of a commercial food establishment or an industrial food packaging facility, where the part/items have to be cleaned quicker and more efficiently.

What is desired, therefore, is an automated washing system for cleaning parts/items that is more efficient and allows for items to be loaded and unloaded quicker.

### SUMMARY OF THE INVENTION

In order to overcome the deficiencies of the prior art and to achieve at least some of the objects and advantages listed, the invention comprises in a first embodiment, a washer system for cleaning items, including a wash chamber with a spray bar and a door, and a movable cleaning cart configured to accommodate a plurality of items to be cleaned. The cleaning cart includes a bottom wheel portion configured to be moved on a surface and a top rack portion, wherein the bottom wheel portion and the top rack portion are spaced apart. The cleaning cart is configured to be inserted into the wash chamber through the door and is configured to remain in the wash chamber during a wash cycle, and the spray bar is configured to rotate without any power input.

In some embodiments, the system further includes a cart channel configured to accommodate the bottom wheel portion of the cleaning cart during a wash cycle.

In certain embodiments, the spray bar has an upside-down U shape with a plurality of nozzles positioned along the bar. In some of these embodiments, at least one of the plurality of nozzles is angled with respect to a longitudinal axis of the wash chamber that is perpendicular to the ground.

In some embodiments, the door includes a locking mechanism configured to prevent the cleaning cart from being removed from the wash chamber during a wash cycle.

In some cases, the system also includes at least one pump configured to continuously circulate water through the wash chamber during the wash cycle.

In certain embodiments, at least one of the door and the movable cleaning cart include a ledge angled towards a bottom of the wash chamber and configured to direct water away from a door opening during the wash cycle.

In some embodiments, the system further has an alignment member positioned on the spray bar and configured prevent the spray bar from being oriented in a position that interferes with the movable cleaning cart from being inserted into and out of the wash chamber. In certain of these embodiments, the alignment member is rotationally fixed with respect to the wash cylinder and is configured to mate with a portion of the spray bar to prevent rotation of the spray bar relative the wash cylinder when in an activated position. In additional embodiments, the alignment member has a spring that biases the alignment member into the activated position.

In another embodiment, a washer system for cleaning items includes a wash chamber with a spray bar and a door, and a movable cleaning cart configured to accommodate a plurality of items to be cleaned, wherein the cleaning cart is configured to be inserted into the wash chamber through the door and is configured to remain in the wash chamber during a wash cycle.

In some embodiments, the cleaning cart has a bottom wheel portion configured to be moved on a surface and a top rack portion, wherein the bottom wheel portion and the top rack portion are spaced apart.

In certain embodiments, the spray bar is configured to rotate without any power input.

In some cases, the spray bar may include a plurality of hollow spray arms rotationally coupled to the wash chamber.

In some embodiments, the spray bar has a center spindle rotationally fixed to the wash chamber, wherein the center spindle has a plurality of bores fluidly connected to the plurality of spray arms.

A method of cleaning items in a washer system is also provided, including the steps of loading items to be cleaned in a rack portion of a cleaning cart, transporting the cleaning cart via a bottom wheel portion, inserting the rack portion of the cleaning cart into a wash chamber of the washer system and inserting the wheel portion of the cleaning cart into a cart channel of the washer system, closing a door of the wash chamber to lock the cleaning cart inside the wash chamber, and initiating a wash cycle. The cleaning cart remains in the wash chamber during the cleaning cycle.

In some embodiments, the method also includes the step of sensing a position of the door via at least one sensor and aborting the wash cycle if the door is not in a closed position.

In certain embodiments, the method further includes the step of pumping water through a spray bar positioned on the wash chamber during the cleaning cycle, wherein the spray bar rotates relative the wash chamber without any power input. In some of these embodiments, the spray bar has a plurality of nozzles and the method further includes the step of adjusting a position of at least one of the plurality of nozzles with respect to a longitudinal axis of the wash chamber that is perpendicular to the ground. In additional embodiments, the method includes the step of activating an alignment member provided on the spray bar to rotationally fix the spray bar relative the wash chamber when the washer system is not in the cleaning cycle.

Further objects, aspects, features, and embodiments of the present technology will be apparent from the drawing Figures and below description.

### BRIEF DESCRIPTION OF THE DRAWINGS

FIG. 1A shows a general view of a washer system according to an exemplary embodiment of the technology.

FIG. 1B shows a general view of a sanitation cart system according to an exemplary embodiment of the technology.

FIG. 2A shows a first embodiment of a door configuration of the washer system, showing the door in an opened position.

FIG. 2B shows the door configuration of the washer system of FIG. 2A, showing the door in a closed position.

FIG. 3A shows a second embodiment of a door configuration of the washer system, showing the door in an opened position.

FIG. 3B shows the door configuration of the washer system of FIG. 3A, showing the door in a closed position.

FIG. 4A shows a general view of a cart alignment system of the washer system.

FIG. 4B shows an enlarged view of the cart alignment system of FIG. 4A.

FIG. 5 shows an internal view of the washer system.

FIG. 6A shows an enlarged view of the spray bar component of FIG. 6B.

FIG. 6B shows a general view of a spray bar component of the washer system.

FIG. 7A shows an exploded view of the spray bar component of FIG. 6.

FIG. 7B shows an exploded view of another embodiment of the spray bar component.

FIG. 8 shows a cross-sectional view of an embodiment of a door component of the washer system.

FIG. 9A shows a cross-section view of the door component of FIG. 8.

FIGS. 9B and 9C show enlarged views of the door component of FIG. 8.

FIG. 10 shows an enlarged view of another embodiment of the door component of the washer system.

FIG. 11A shows a partial enlarged front view of the cart alignment system of the washer system.

FIG. 11B shows a partial enlarged bottom isometric view of the cart alignment system of the washer system.

FIGS. 12A and 12B show partial bottom views of the cart alignment system, showing the cart being inserted into the washer system.

FIG. 13 shows a partial enlarged view of the washer system, showing the cart being inserted into the washer system.

FIG. 14A shows a cross-sectional view of the washer system.

FIG. 14B shows a partial enlarged cross-sectional view of the washer system of FIG. 14A.

FIG. 15 shows a partial enlarged cross-sectional view of the door seal of the washer system.

FIG. 16A shows a partial view of the spray bar of the washer system.

FIGS. 16B and 16C show partial enlarged views of the spray bar of FIG. 16A in a closed and opened positions respectively.

### DETAILED DESCRIPTION OF THE INVENTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The term “about” or “approximately” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ” , “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, the singular forms “a,” “an,” and “the” include plural referents unless the content clearly dictates otherwise.

The term “comprising” is synonymous with “including,” “having,” “containing,” or “characterized by.” These terms are inclusive and open-ended and do not exclude additional, unrecited elements or method steps.

The present technology relates to a parts washer. Unlike conventional washers, where parts or items are loaded into the machine, the door is closed, and a start button is pressed to initiate a cleaning cycle, some embodiments of the present technology include a removable sanitation cart system that can be wheeled away, allowing for it to be loaded/unloaded while another cart is running through a cleaning cycle, which advantageously makes the washing/cleaning process quicker and more efficient.

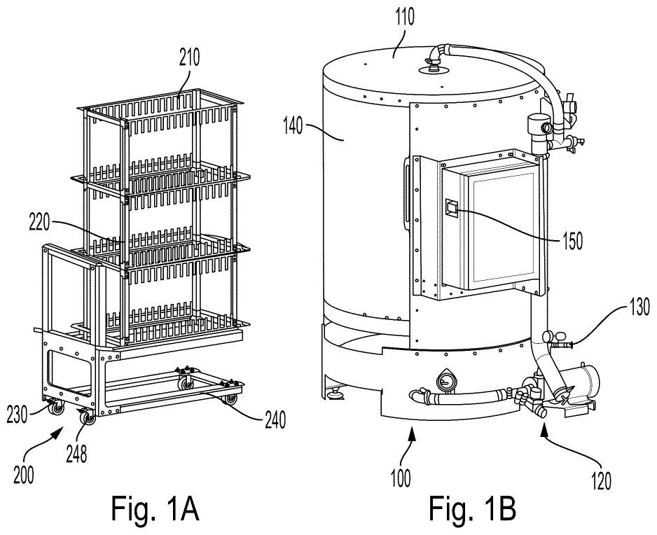

FIGS. 1A and 1B show an exemplary embodiment of the technology, which generally comprises a cabinet washer system 100 and a sanitation cart system 200. Dirty parts/items are loaded onto loading racks 210 and wheeled into the cabinet washer 100, which cleans the dirty parts/items that were loaded onto the sanitation cart 200. The dimensions shown in FIGS. 1A and 1B are exemplary only and other embodiments may have different dimensions.

As shown in FIG. 1B, the cabinet washer system comprises several parts. There is a wash cylinder 110 which contains water for continuous recirculation of water during a wash cycle. The water capacity of the wash cylinder 110 may depend on the desired size and capacity of the washer system. In some embodiments, the wash cylinder 110 may be capable of holding one or more gallons of water. The wash cylinder 110 may also contain one or more internal cleaning products or sprays that facilitate cleaning of the items/parts as described in more detail below. The water is continuously circulated in the washer system 100 through external plumbing coupled to the wash cylinder 110. The external plumbing is coupled to an inlet port 130 of the wash cylinder for supplying fresh water to the wash cylinder and to an outlet port 120 of the wash cylinder for discarding the dirty water from the wash cycle.

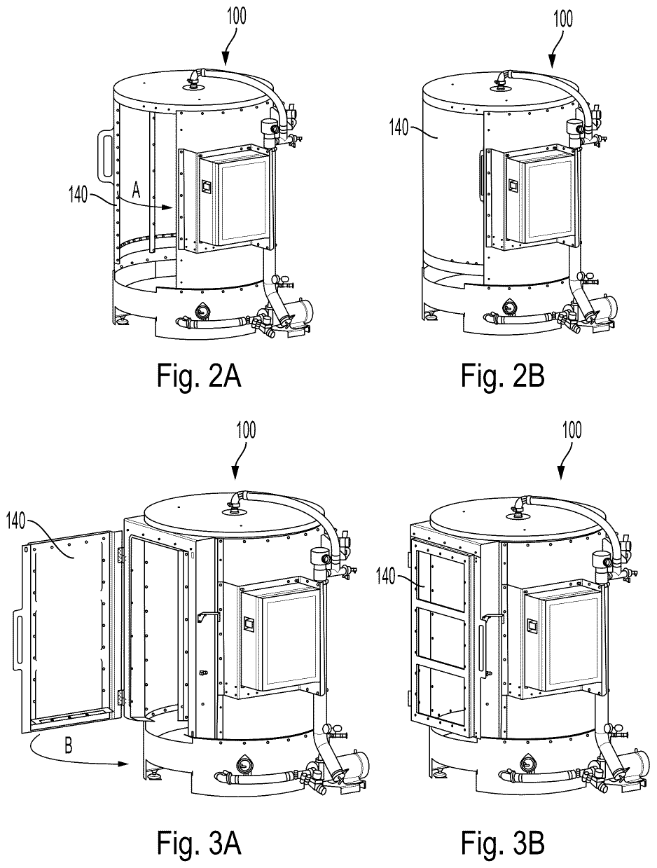

The cabinet washer system 100 further comprises an access door 140, which, when opened, allows the sanitation cart 200 to be positioned inside the wash cylinder 110. When closed, the access door 140 acts as a locking mechanism, preventing the sanitation cart from being removed from the wash cylinder while the washer system is running. Any suitable locking mechanism known in the art may be used to keep the door closed during the wash cycle. The access door may have several suitable configurations, such as a sliding door and a swinging door, which are shown in FIGS. 2A-2B and 3A-3B and are discussed below in more detail.

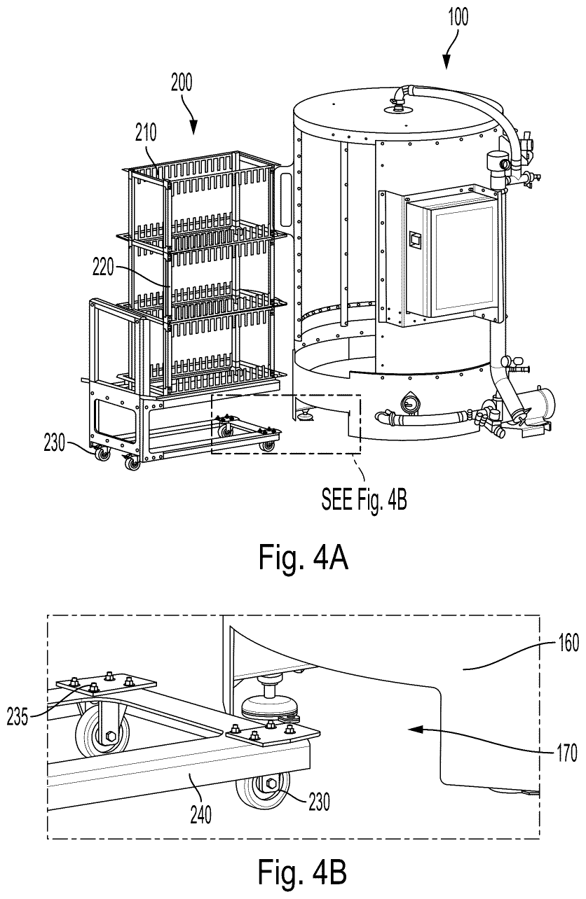

As illustrated in FIGS. 1B and 4A-4B, the sanitation cart 200 is a cart system that may be shaped like a shopping cart. The sanitation cart 200 comprises a rack section 210 configured to house/support a plurality of parts/items to be cleaned. The rack section 210 includes one or more rows of racks extending horizontally between four vertical poles 220 positioned in each corner of the rack. In the embodiment shown in FIGS. 1A-1B and 4A-4B, the rack section 210 has four rows of racks. It is understood that any number of rows of racks may be included in the rack system depending on the desired application. Also, individual pegs in each row of racks may be spaced apart at different distances as desired-closer together for smaller items and further apart for larger items to be cleaned.

A bottom part of the sanitation cart system may include a plurality of wheels 230 that allow the cart to be moved on a surface. The wheels may include a locking mechanism 248 to allow the cart to be locked in place once it is positioned inside the washer system. Any suitable lock mechanism known in the art may be used. In an embodiment shown in FIG. 4B, the bottom part of the cart system comprises a frame 240 that is spaced apart from the rows of racks 210. This allows the bottom part to be positioned in a frame 160 of the washer system, while the rows of racks 210 are positioned in the wash cylinder 110, as described in more detail below.

The cabinet washer system 100 comprises a frame 160 positioned at the bottom of the system. The frame 160 supports the wash cylinder 110 and has ports for the external plumbing system. As seen in FIG. 4B, the frame includes a cart alignment channel 170 on one side shaped such that it can accommodate the bottom portion 240 of the sanitation cart 200. The bottom portion of the rack system is guided into the bottom of the frame through the cart alignment channel, as illustrated in FIG. 4B.

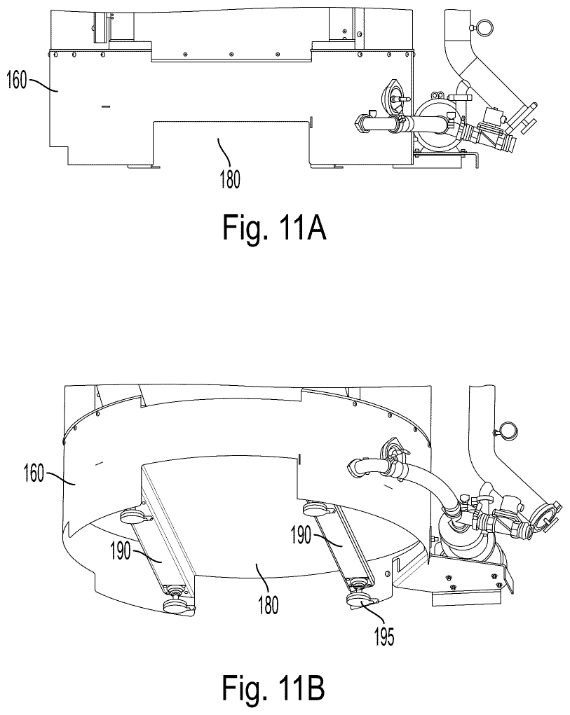

As shown in FIGS. 11A and 11B, a cutout 180 may be provided on the bottom/frame portion 160 of the wash cylinder such that the bottom portion 240 of the sanitation cart system 200 may be pushed under the wash cylinder while allowing the top portion to be overhung inside the wash cylinder. The cutouts may be provided on both the front and the back of the wash cylinder, as seen in FIG. 11B. The cutouts are connected via a full-length channel 190 that may be welded to the edges of the cutouts. The channel may be made with stainless steel or any other suitable material. The channel 190 may aid in the alignment of the sanitation cart system. A plurality of support legs 195 may be positioned on the channel 190 or at any other location at the bottom of the washer cylinder to support the cylinder on a surface, as seen in FIG. 11B.

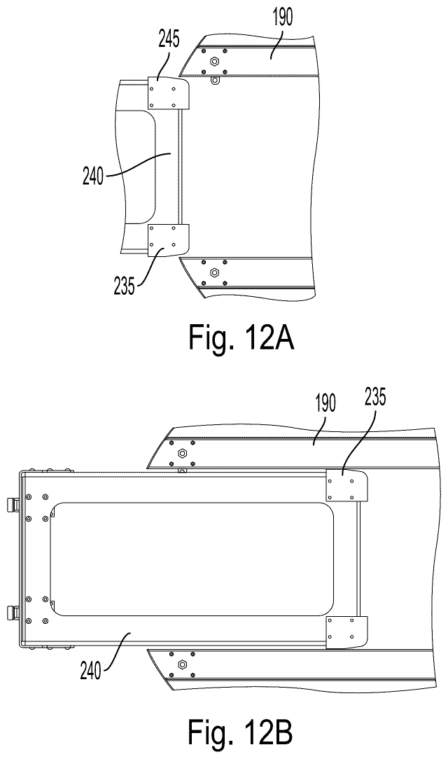

In some embodiments, the bottom portion of the sanitation rack may include tapered sliding pads 235 made with plastic or any other suitable material, as shown in FIG. 4B. The sliding pads facilitate alignment of the sanitation cart 200 with the wash cylinder 110 via the cart alignment channel 190. As seen in FIGS. 12A and 12B, as the sanitation cart 200 is pushed into the cutout 180 and the channel 190 located at the bottom of the wash cylinder 110, tapered edges 245 on the plastic wear pads 235 located on the sanitation cart may act as guides, facilitating centering of the sanitation cart in the channel as the cart is being pushed forward. Once the cart is inserted past the tapered edges 245, there is enough clearance between the flat edges of the wear pads 235 and the channel 190 to allow the sanitation cart to be pushed forward without causing any substantial misalignment between the sanitation cart and the wash cylinder. This ensures that the sanitation cart is properly aligned with the wash cylinder before the wash cycle is initiated.

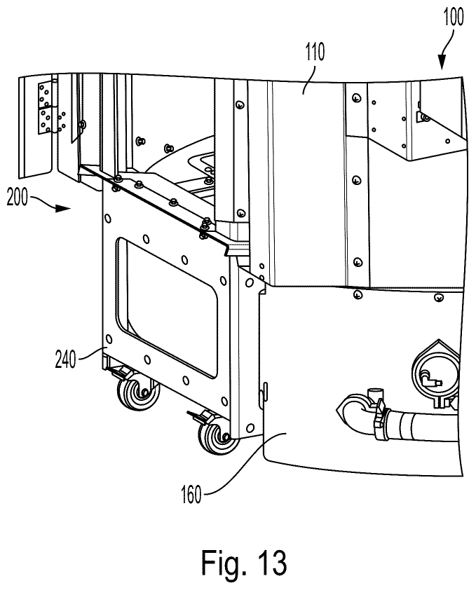

Once the sanitation cart 200 has made physical contact with the wash cylinder 110, the sanitation cart has been fully inserted into the wash cylinder, as illustrated in FIG. 13. At this point, the door may be closed, which will prevent the sanitation cart from being removed and will ensure that water from the cleaning sprays does not leave the wash cylinder during the washing cycle. Next, a wash program can be selected and initiated by the operator by engaging with a user interface 150, such as, e.g., a touch screen provided on the washer system, as shown in FIG. 1B.

Once the sanitation cart 200 is fully pushed into and positioned inside the wash cylinder 110, the door 140 is closed before any wash cycle can start and to prevent the sanitation cart from being removed from the wash cylinder during operation. The system may use a sensor to ensure that the door is closed. The sensor may be connected to a processor that controls the operation of the system, including the start of the wash cycle. Once the sensor senses that the door is fully closed, it sends a signal to the processor, which in turn enables the wash cycle to begin. The wash cycle may be initiated by the system automatically upon receiving the closed-door signal from the sensor or may be manually initiated by a user once the closed door signal is displayed.

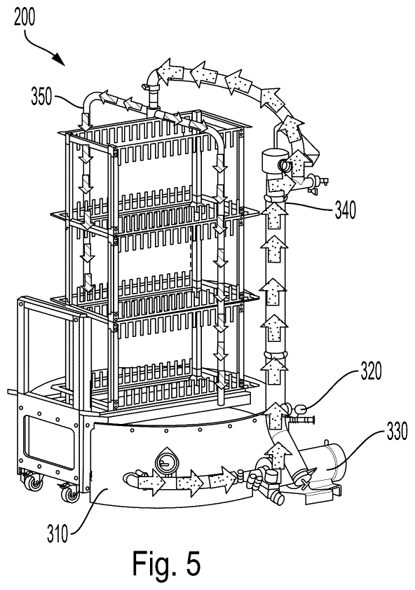

With reference to FIG. 5, once a wash cycle starts, water is filled into the bottom of the wash cylinder, which may also be referred to as a sump 310, through an automated water fill valve 320. Once a certain volume of water in the wash cylinder has been reached, a motor 330 may start, pumping water from the sump 310 through the external piping 340 and into a cleaning spray system 350, which will perform the action of cleaning the dirty parts/items positioned in the sanitizing cart system. The direction of water flow through the system is illustrated by arrows in FIG. 5.

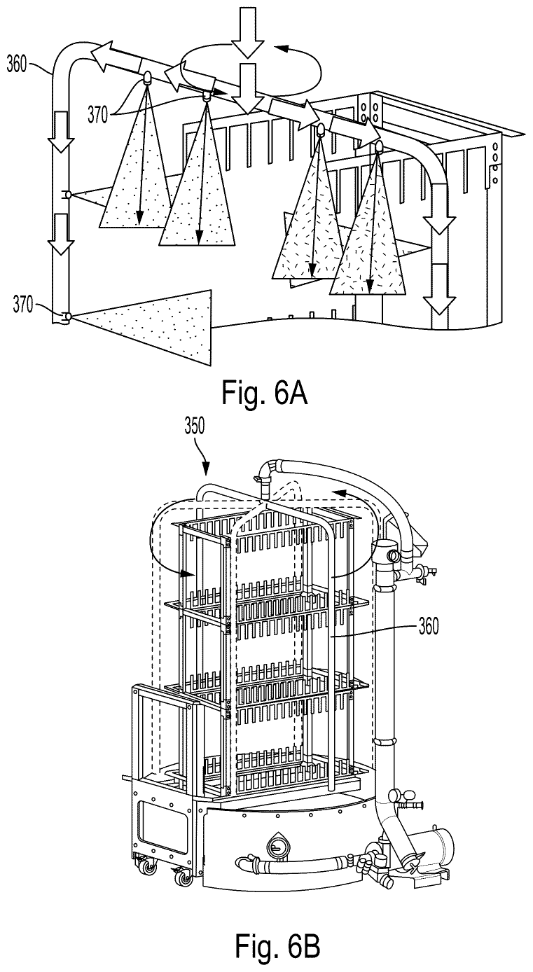

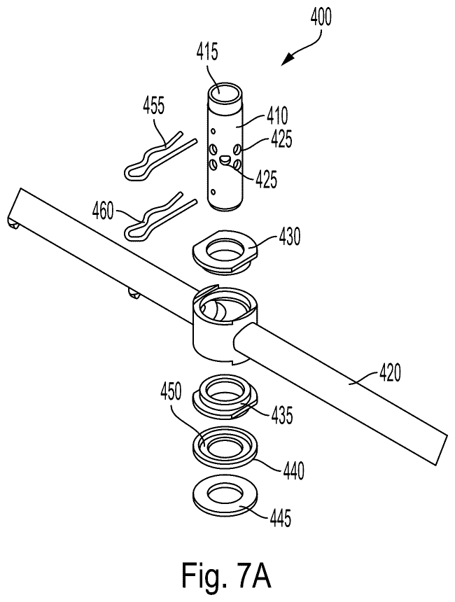

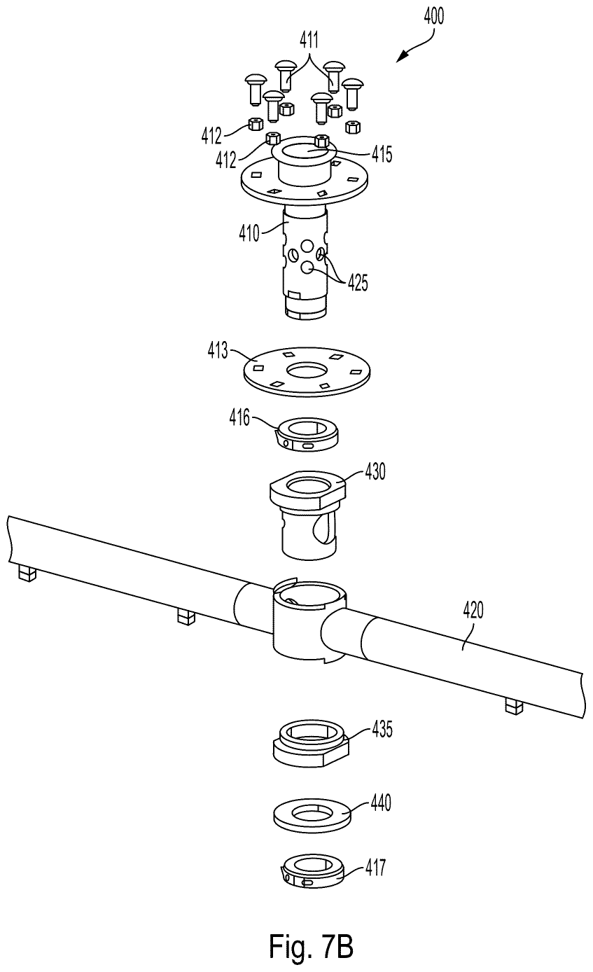

One exemplary embodiment of the cleaning spray system 350 is illustrated in FIGS. 6A-7A. The spray system 350 comprises a spray bar 360 with a plurality of nozzles 370 located at several locations of the spray bar. Water pumped into the spray system from the sump will exit through the plurality of spray nozzles 370 onto the dirty parts/items positioned in the rows of racks in the sanitizing cart system. The water flow direction is illustrated by arrows in FIG. 6A. The spray nozzles 370 may serve several purposes. The first purpose is to provide the active action of cleaning the dirty parts/items. Water exiting the plurality of spray nozzles 370 will produce a pressurized fan that contacts the dirty parts/items, both knocking off any dirty soils and applying a cleaning chemical mixture, as shown in FIG. 6A. Another purpose is to provide rotation to the spray bar. The spray nozzles may be angled either towards or away from a longitudinal axis of the washer system that is perpendicular to the ground, as illustrated by arrows in FIG. 6A. This enables the nozzles to provide both rotation and cleaning actions. Any suitable nozzles known in the art may be used with the spray system.

The spray bar may have an upside down “U” shape, as shown in FIG. 5. The spray bar may be configured to rotate around the dirty items/parts positioned in the racks without any additional power assistance, as shown by arrows in FIGS. 6A and 6B. The water pressure in the spray bar generated by the pump in conjunction with the orientation of the spray nozzles generates the rotational movement of the spray bar. As shown in FIG. 6A, one or more spray nozzles in the embodiment shown on the lower vertical portions of the spray bar provide a thrust via the water pressure that causes rotation of the spray bar.

FIG. 7A illustrates an exploded view of an exemplary embodiment of a center hub 400 of the spray bar design. There is a center spindle 410 that is a fixed, non-rotating portion coupled to the wash cylinder 110. Water flows through a center bore 415 of the center spindle, and a plurality of cross-drilled holes 425 allow water to flow to a spray arm assembly 420 coupled to the center spindle 410. The spray arm assembly 420 may be a solid, welded part that has an upper bushing 430 and a lower bushing 435 allowing the spray arm assembly to freely spin about the center spindle. The spray arm may be made with any suitable material, such as metal or hard plastic.

A thrust bearing plate 440 is installed under the spray arm assembly. Due to the overall heavier weight of the spray bar assembly, the present inventors have discovered that the thrust bearing plate facilitates operational smoothness and proper rotation speed of the spray bar assembly. An inner diameter of the thrust bearing plate 440 is configured such that it is a tight fit on the center spindle 410. The thrust bearing plate may have a recessed center portion 450 to create an area for water to accumulate and provide lubrication between the lower bushing 435 and the thrust bearing plate 440. The upper and lower bushings 430, 435 and the thrust bearing plate 440 may be made with plastic or another suitable material. There is a washer 445 placed under the thrust bearing plate to provide additional support. The washer may be made with stainless steel. The spray arm assembly, thrust bearing plate and washer are all slid onto the center spindle, as shown in FIG. 7A, and held in place vertically with a stopper. The stopper may be a cotter pin 455. A second stopper 460 may be used to hold a door assembly in a closed position.

FIG. 7B illustrates an exploded view of another exemplary embodiment of the center hub 400 of the spray bar design. In this embodiment, the stoppers/pins are replaced by one or more collars, such as split collars, that function to hold all components on the center spindle 415 in place. As shown in this figure, an upper shaft collar 416 and a lower shaft collar 417 may be provided. The collars are inserted onto the spray bar shaft and are clamped in place using screws. It is noted that other types of stopper members may also be used in accordance with the present invention. The center hub 400 may further include a connector member, such as a gasket 413 with a plurality of screws 411 and nuts 412 to couple the center hub to the wash cylinder 110.

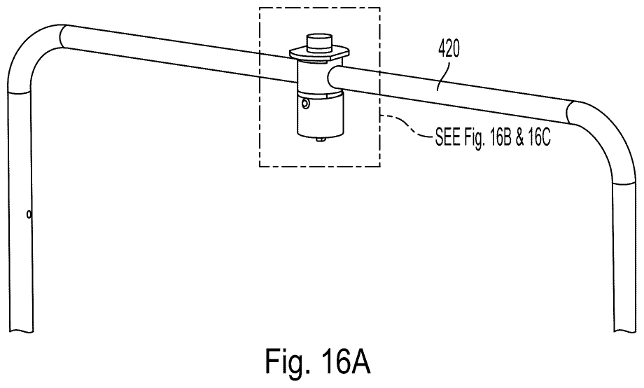

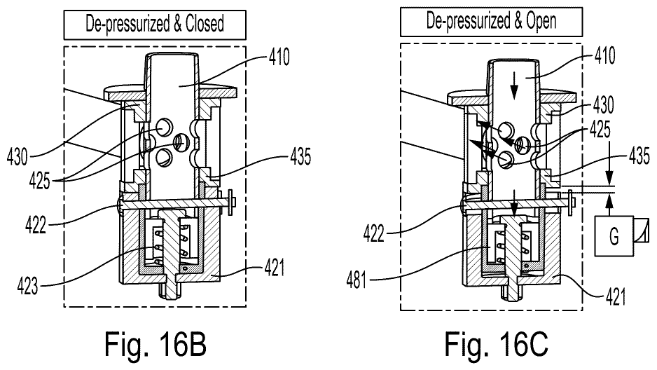

When water is not being pumped into the spray bar, the spray bar is free-rotating and may be oriented in any direction. In some embodiments, the washer system may also include an alignment member to prevent the spray bar from rotating and orienting in a way that could prevent the sanitation cart from being inserted into and out of the wash cylinder when the wash cycle is not initiated, and the water is not being pumped through the system. As illustrated in FIGS. 16A-16C, the alignment member 421 may have a tapered top face fixed from rotating by an alignment pin 422—i.e., the alignment pin rotationally fixes the alignment member with respect to the wash cylinder 110 when in an activated position as shown in FIG. 16B. The top tapered face pushes against the bottom spray bar bearing 435, which may also be tapered to accommodate the top tapered face of the alignment member. The alignment member 421 may be spring loaded 423, such that when the pump is not running, the alignment member 421 pushes against the bottom spray bar bearing 435, forcing it to stop in a specific location, as shown in FIG. 16B. In some embodiments, the alignment member 421 is part of a larger assembly that may function like a check valve. A plate 481 backed by a spring may be located inside the center spindle 410. When water is pumped into the spray bar, the pressure generated will push downward on the plate in the direction shown by arrows, pushing the alignment member 421 downward and creating a gap G between the alignment member 421 and the bottom spray bar bearing 435, as shown in FIG. 16C. This disengages the top face of the alignment member from the bottom spray bar bearing, which allows the spray bar 420 to spin freely. When the pump stops, pressure is released from the spring, allowing the spring 423 to push the alignment member 421 upward, forcing the spray bar 420 to stop in a desired location.

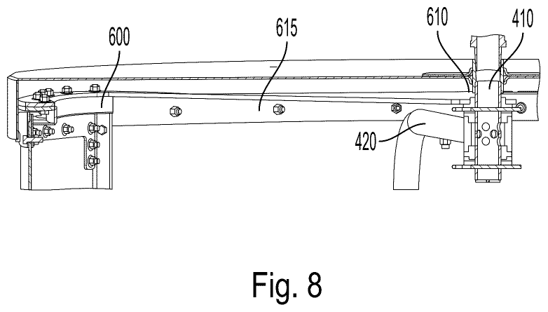

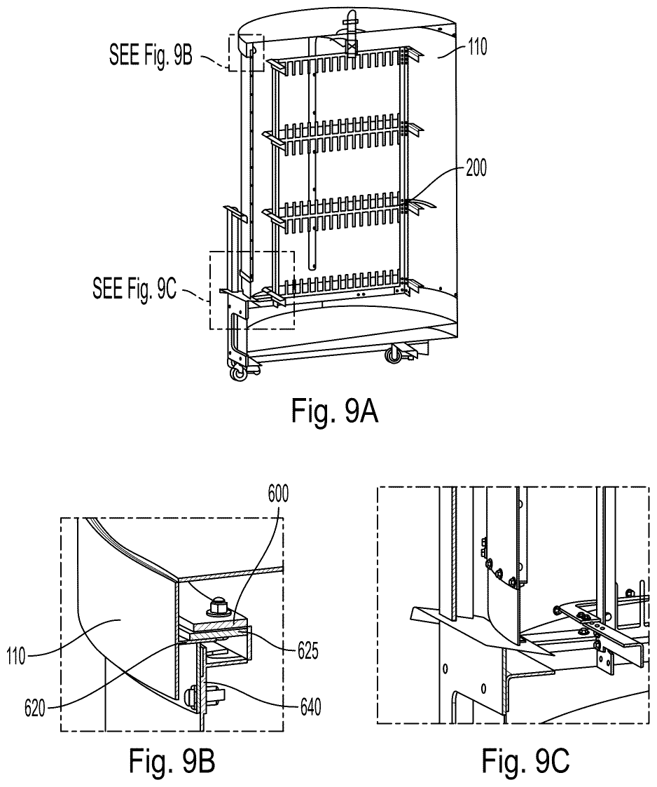

As illustrated in FIGS. 2A-2B and 8-9C, the door 140 may be a sliding door construct. The sliding door may have a frame 600 and may pivot about the center spindle 410, which is centered at the top of the wash cylinder 110. A bushing 610 may be installed onto the sliding door frame 600 to allow for rotation around the center spindle 410. In some embodiments, the door construct may include one or more support arms 615 extending outward from the center spindle 410. The support arms 615 provide a surface for the sliding door assembly to rest on an inner ledge 620 affixed on the upper portion of the wash cylinder, as shown in FIG. 9B. There may be a wear pad 625 provided to separate the door frame 600 from the inner ledge 620, which may be made out of plastic or another suitable material. The wear pad becomes lubricated by water from the wash cycles, which improves the ease with which the door slides and reduces wear on the inner ledge during use of the washer system.

The sliding door design is intended to keep water distributed by the spray arm 420 inside the wash cylinder by creating a labyrinth type seal design on the top portion of the wash cylinder, as seen in FIG. 9B. The door may include flexible rubber seals 640 installed on the sides of the sliding door, which create a seal with the inside of the wash cylinder, preventing any water from escaping the wash cylinder during the wash cycle. A ledge may be provided at the bottom of the door to deflect water back into the wash cylinder. The sanitation cart assembly 200 may include a sloped plate 645, as shown in FIG. 9C, which helps to direct the deflected water back into the sump.

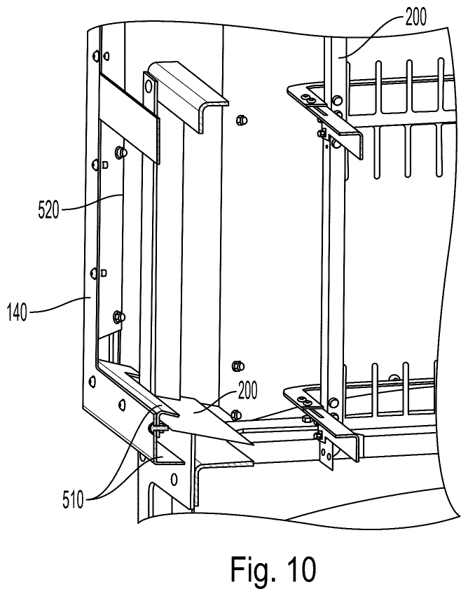

FIGS. 3A-3B and 10 illustrate a swing door embodiment of the washer system. The swing door assembly 140 may be provided with one or more staggered plates 510 that overlap each other and are angled back into the wash cylinder. This design assists with directing the wash distributed by the spray arm 420 back into the wash cylinder 110. In some embodiments, connection points may be formed by overhanging steel plates. Additionally, the connection points may utilize rubber members 520 to force the water to move in the desired direction back into the wash cylinder 110.

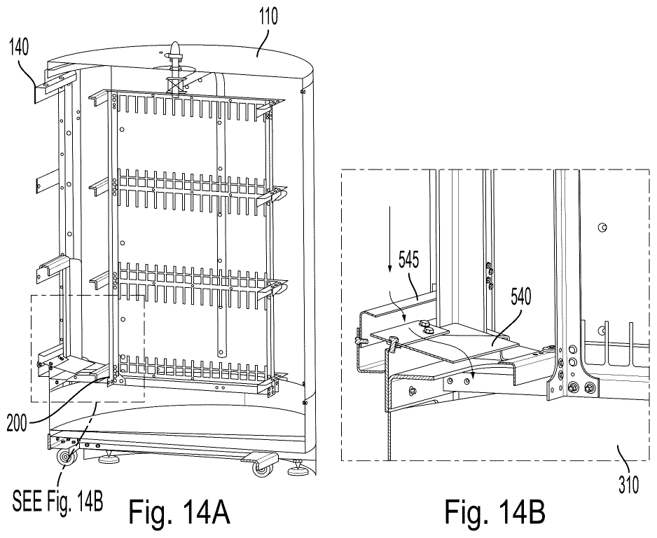

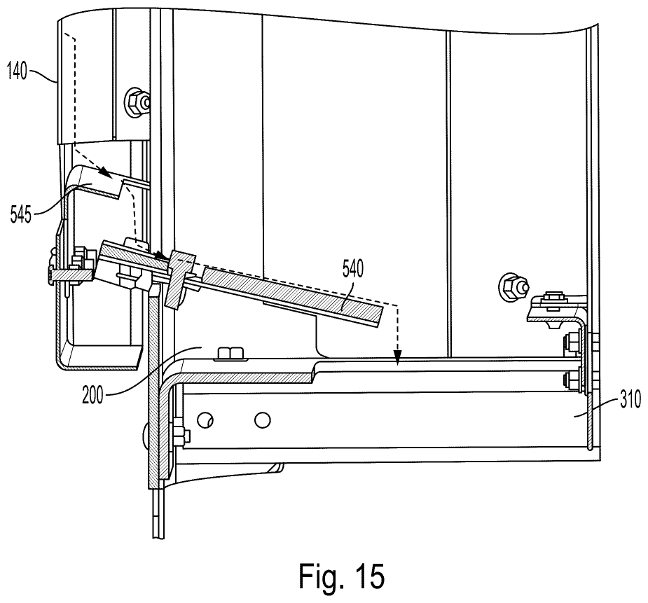

FIGS. 14A, 14B, and 15 illustrate the integration between the door 140 and the sanitation cart 200, creating a path for water to return into the bottom section of the wash cylinder 310 (the sump). As the spray arm sprays water onto the sanitation cart 200 in the direction shown by arrows in FIG. 14A, overspray may cover all internal surfaces inside the wash cylinder 110. While inside the circular portion of the wash cylinder, this overspray may simply drip down until it reaches the sump 310. In some embodiments, the door portion may overhang the sump 310 and/or have cutouts to accommodate the sanitation cart 200. To prevent any possible leaking through this opening, one or more ledges may be provided on the door 140 and/or on the sanitation cart 200 angled towards the sump. FIG. 14B illustrates a door ledge 545 and a cart ledge 540, wherein the door ledge overhangs the cart ledge 540. These ledges may be staggered, but may overlap, creating a path for water to return to the sump without allowing any major leak points. Water that drips down the door will reach the angled door ledge, directing water onto the sanitation cart, as shown by arrows in FIG. 14B. Water on the sanitation cart 200 will then continue to drain towards the sump 310. A side view illustrating this embodiment is shown in FIG. 15, showing a water flow path through the system.

Although the technology has been described and illustrated with respect to exemplary embodiments thereof, it should be understood by those skilled in the art that the foregoing and various other changes, omissions and additions may be made therein and thereto, without parting from the spirit and scope of the present technology. It should also be understood that features described and illustrated in reference to one embodiment may be employed in other embodiments as appropriate.

What is claimed is:

1. A washer system for cleaning items, comprising:
a wash chamber comprising a spray bar and a door; and
a movable cleaning cart configured to accommodate a plurality of items to be cleaned;
wherein the cleaning cart comprises a bottom wheel portion configured to be moved on a surface and a top rack portion, wherein the bottom wheel portion and the top rack portion are spaced apart;
wherein the cleaning cart is configured to be inserted into the wash chamber through the door and is configured to remain in the wash chamber during a wash cycle; and
wherein the spray bar is configured to rotate without any power input.

2. The washer system of claim 1, further comprising a cart channel configured to accommodate the bottom wheel portion of the cleaning cart during a wash cycle.

3. The washer system of claim 1, wherein the spray bar comprises an upside-down U shape with a plurality of nozzles positioned along the bar.

4. The washer system of claim 3, wherein at least one of the plurality of nozzles is angled with respect to a longitudinal axis of the wash chamber that is perpendicular to the ground.

5. The washer system of claim 1, wherein the door comprises a locking mechanism configured to prevent the cleaning cart from being removed from the wash chamber during a wash cycle.

6. The washer system of claim 1, further comprising at least one pump configured to continuously circulate water through the wash chamber during the wash cycle.

7. The washer system of claim 1, wherein at least one of the door and the movable cleaning cart comprise a ledge angled towards a bottom of the wash chamber and configured to direct water away from a door opening during the wash cycle.

8. The washer system of claim 1, further comprising an alignment member positioned on the spray bar and configured prevent the spray bar from being oriented in a position that interferes with the movable cleaning cart from being inserted into and out of the wash chamber.

9. The washer system of claim 8, wherein the alignment member is rotationally fixed with respect to the wash cylinder and is configured to mate with a portion of the spray bar to prevent rotation of the spray bar relative the wash cylinder when in an activated position.

10. The washer system of claim 9, wherein the alignment member comprises a spring that biases the alignment member into the activated position.

11. A washer system for cleaning items, comprising:
a wash chamber comprising a spray bar and a door, and
a movable cleaning cart configured to accommodate a plurality of items to be cleaned,
wherein the cleaning cart is configured to be inserted into the wash chamber through the door and is configured to remain in the wash chamber during a wash cycle.

12. The washer system of claim 11, wherein the cleaning cart comprises a bottom wheel portion configured to be moved on a surface and a top rack portion, wherein the bottom wheel portion and the top rack portion are spaced apart.

13. The washer system of claim 11, wherein the spray bar is configured to rotate without any power input.

14. The washer system of claim 11, wherein the spray bar comprises a plurality of hollow spray arms rotationally coupled to the wash chamber.

15. The washer system of claim 14, wherein the spray bar further comprises a center spindle rotationally fixed to the wash chamber, wherein the center spindle comprises a plurality of bores fluidly connected to the plurality of spray arms.

16. A method of cleaning items in a washer system, comprising the steps of:
loading items to be cleaned in a rack portion of a cleaning cart,
transporting the cleaning cart via a bottom wheel portion,
inserting the rack portion of the cleaning cart into a wash chamber of the washer system and inserting the wheel portion of the cleaning cart into a cart channel of the washer system,
closing a door of the wash chamber to lock the cleaning cart inside the wash chamber, and
initiating a wash cycle,
wherein the cleaning cart remains in the wash chamber during the cleaning cycle.

17. The method of cleaning items of claim 16, further comprising the step of sensing a position of the door via at least one sensor and aborting the wash cycle if the door is not in a closed position.

18. The method of cleaning items of claim 16, further comprising the step of pumping water through a spray bar positioned on the wash chamber during the cleaning cycle, wherein the spray bar rotates relative the wash chamber without any power input.

19. The method of cleaning items of claim 18, wherein the spray bar comprises a plurality of nozzles and the method further comprises the step of adjusting a position of at least one of the plurality of nozzles with respect to a longitudinal axis of the wash chamber that is perpendicular to the ground.

20. The method of cleaning items of claim 18, further comprising the step of activating an alignment member provided on the spray bar to rotationally fix the spray bar relative the wash chamber when the washer system is not in the cleaning cycle.
